(19) United States
(12) Patent Application Publication
(10) Pub. No.: US 2006/0048923 A1
(43) Pub. Date: Mar. 9, 2006

(54) Heat exchanger, methods and means for making same

(76) Inventor: Jean-Paul Domen, Vauchretien (FR)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/537,374

(22) PCT Filed: Dec. 12, 2003
(86) PCT No.: PCT/FR03/03692

§ 371 Date: Jun. 3, 2005

(30) Foreign Application Priority Data
Dec. 13, 2002 (FR) 02/15821

(51) Int. Cl. F28D 1/00; B28B 5/00

(52) U.S. Cl. 165/148; 264/250

(57) ABSTRACT

The invention concerns an elementary heat exchanger comprising a single elongated active monobloc component (10), enclosed in a casing provided with coolant inlet and outlet. The casing consists of two half-shells (11a-b), welded together (98a-b, 114a-b), fixed to the active component. The active component (10) comprises a fishbone cross-section (10a-b), whereof the bones (12a-b) are hollow, oblique, embossed and globally symmetrical. The active component is made from a blank made of resistant material (for example a polymer), in the form of biconvex stiff-walled bellows (33-35-37-39), comparable to those of an accordion whereof the peaks have been struck off (36), narrow bases (38) and a spacing (16) between said bases.

The invention relates to a heat exchanger, of an entirely new type, as well as its method and means of production.

Exchangers of heat between two fluids are used whenever the recovery or dissipation of heat is necessary, but without mixing the fluid which transports it with. the fluid which evacuates it. In heat exchangers, at least one of the two fluids is confined, i.e. forced in its totality to circulate in a limited space, while the other can be only partially confined or not at all. This is the case, for example, with hot water central heating radiators, depending on whether they are partially covered or not. It is also the case with the heat exchanger of a heat pump with a cold gas flowing through it and submerged in a water course. When the two fluids concerned must be confined, in particular to be able to be recovered and recycled, the heat exchanger to be used must then include one or more active internal parts, surrounded by an external part or casing, all equipped with connection branches, the external part generally being heat-insulated.

There are several modes of operation of heat exchangers: counter-current, co-current and cross-current. The advantage of an exchanger operating in counter-current mode, is that it allows the transfer, from the hot fluid to the cold fluid, of practically all the difference in temperature which exists between them. The co-current exchanger allows only an intermediate temperature between those of the two fluids to be reached. As regards the cross-current exchanger, its structure being different to that of the preceding, it is less effective than the counter-current version but nevertheless well suited to particular uses (customary car radiators, for example).

All heat exchangers must, in order to have a maximum efficiency, have the following characteristics: have (1) active surfaces, i.e. directly participating in the heat exchange, which are as large as possible, (2) passage thicknesses for the two fluids which are both small and more or less constant along the whole length of the active surfaces, so that practically the entire mass of the confined fluid or fluids participates in the exchange, and (3) a substantial total passage section for the confined fluid or fluids, proportional to the thermal energy to be exchanged, in order to minimize losses of head.

In numerous industrial applications, the active walls of the counter-current heat exchangers used are made of a metal which is a good conductor of heat, suited to the fluids concerned. Stainless steel of a particular type, and thus costly, is for example required where one of the two fluids is relatively corrosive (sea water for example). There are several metal models of heat exchangers for two confined fluids circulating in counter-current on the market. They are for the most part constituted by a stack of rectangular plates with large dimensions, separated from each other by tight joints, and by connecting chambers allowing each of the faces of these plates to be in contact with a different fluid. In order to satisfy the characteristics of all the heat exchangers mentioned above, this type of apparatus is necessarily heavy and bulky in all three dimensions. In order to reduce losses, its optimal form is close to that of the cube. These two disadvantages are additional to the disadvantage of their high manufacturing cost, which is a result of the number of operations to be carried out, proportional to the number of plates to be assembled. In the case of a heat exchanger for corrosive fluid, the relatively high price of the metal used must also be taken into account.

Counter-current heat exchangers made of plastic are also used because of the stable characteristics of this material, which allows them to withstand the majority of corrosive fluids without suffering damage. Added to this first advantage is their lower weight and raw material cost. Overall, these advantages largely compensate for the thermal conductivity deficiencies of plastics and the fact that the maximum temperature of the fluids concerned must generally be less than 100 or 120° C. Until now, it has been customary to use plastic to make heat exchangers between two confined fluids circulating in counter-current, using a bundle of small-diameter, relatively long pipes installed zig-zag in a large-diameter pipe. The fluids inside and outside the small pipes circulate in reverse direction. The advantage of the pipes with small diameter is, of course, that they best increase the active exchange surfaces for a given section of the large pipe and reduce the maximum thicknesses of fluid surrounding these small pipes, which improves the exchanges between the inside and the outside of these pipes. But this type of heat exchanger presents a major disadvantage resulting from the need to realize a tight connection branch at the two ends of each pipe and, moreover, to ensure that the constituted bundle is, over its whole length, regularly arranged on the inside of the large pipe. This is so that all the walls of the internal pipes are surrounded by the same reduced fluid thickness, so that the heat exchange can be carried out in the best conditions. This assembly operation is also relatively costly, because of the great number of minutely detailed assembly and welding operations which it comprises.

In the case of certain devices for heat exchange between a confined fluid and the outside air, incorporated in refrigerators and/or freezers, such as those described in the European patent application published under the No. EP 1,225,505 A1, on 8, Aug. 2001, the elementary heat exchangers which constitute them are metal and formed by two rectangular plates which are corrugated and/or are provided with projections. These plates contain two connection rings installed in two opposite corners and they are mounted symmetrically one on the other, so as to be able to constitute hollow and flat elements, equipped with a diametrically opposed inlet and outlet. The peripheral edges of each pair of plates and rings are welded to each other in a continuous manner, and the contact zones of the projections or the contact lines of the peaks of the corrugations, spot welded at points which are relatively spaced out. In order to reduce the cost of assembling several elementary heat exchangers of this type which are hollow and flat, automatic processes have been developed, in particular that described in U.S. Pat. No. 4,860,421 of 29^{th} Aug. 1989.

The first subject of the invention is a method for producing an elementary heat exchanger, of an entirely new type, the specifications of which are as follows: to be single-piece, i.e. without assembly or welding, and very efficient, of limited bulk, small weight, low production cost and, generally, intrinsically stable vis-à-vis corrosive fluids.

The second subject of the invention is an elementary heat exchanger of this type, comprising a compact single active part.

The third subject of the invention relates to such an elementary heat exchanger, easily produced using machine tools and equipment for automatic production which are customary in the industry.

The fourth subject of the invention is a preform of this elementary heat exchanger, which a simple operation can transform into an active part of this exchanger.

The fifth subject of the invention is a particular mold, suited to the production of such a preform of the active part of this elementary heat exchanger.

According to the invention, a method for producing a single-piece elementary heat exchanger, which is very efficienct, of limited bulk, small weight, low production costs and, generally, intrinsically stable is characterized in that it comprises the following steps:
producing in a mold, by thermo-blow molding or hydroforming, a preform made of a suitable material, constituted by a stack of globally biconvex bellows, relatively deep in relation to the transverse dimension of the preform and comparable to those of an accordion, said bellows comprising elongated central parts, equipped with end connectors, flanks, tips and bottoms having respectively appropriate shapes so that these flanks have a much greater rigidity than those of the bottoms and the tips, said stack itself being equipped with two connection pipes, centred on the stacking axes of said end connectors;
the elements constituting this preform having suitable temperatures, flexibilities and elasticities, applying an internal depression and/or external compression forces to them, parallel to the stacking axis of the bellows, then easing and/or stopping the depression and/or compression forces, when the thus-produced compressed part becomes a stack of pairs of hollow plates, communicating and globally symmetrical, with small, more or less constant internal thickness and spacing;
if necessary, after cooling the thus-produced part, surrounding it with a member ensuring its clamping, in order to maintain at their initial values the spaces between the walls of the pairs of plates.

According to a particular feature of this method, the mold to be used for its implementation contains flared grooves with rectilinear, narrow and parallel tips and bottoms, the flanks of these grooves are embossed, the humps of one flank facing the hollows of the other.

According to two supplementary features of the above, the median planes of the embossed flanks of the mold form angles of 20 to 30° with their plane of symmetry and their end connectors have profiles with invertible surfaces.

According to the invention, a single-piece elementary heat exchanger which is very efficienct, of limited bulk, small weight, low production cost and, generally, intrinsically stable, is characterized in that:
it is constituted by a single active piece, without assembly or welding, formed by a stack of pairs of elongated hollow plates, communicating and globally symmetrical;
the internal faces of the walls of each hollow plate, as well as the external faces of the walls of two contiguous hollow plates, are separated from one another at all points by narrow substantially constant spaces;
these pairs of hollow plates constitute the elementary conduits of the active part which comprise central parts, the two ends of which are connected to each other by two hollow connectors;
each elementary conduit of the active part has two main feed lines, the axes of which merge with the stacking axes of the end connectors;
one of the ends of each collector ends in a connection pipe of the active part.

According to a particular feature of this heat exchanger, the walls of the pairs of hollow plates are embossed and globally symmetrical, but their median longitudinal planes are perpendicular to their plane of symmetry.

According to another particular feature of this elementary heat exchanger, the walls of the pairs of hollow plates are embossed and globally symmetrical, but their median longitudinal planes together form dihedrals of 120 to 160° and their hollow end connectors have been made from invertible surfaces.

Thanks to these arrangements, several types of elementary heat exchangers can be made, using known techniques, which satisfy the above specifications. The techniques of thermo-blow molding or hydroforming will be used to do this. Thermo-blow molding is the hot forming of polymers or glass under strong pneumatic pressure. This technique is used for the production of containers, flasks and bottles of all types, with relatively complex shapes. Hydroforming is the cold drawing of tubes or metal plates under very high hydraulic pressure. This technique is used in numerous industries to make hollow parts or components with complex shapes.

Thermo-blow molding specialists know from experience that the containers made with this technique cannot have walls of constant thickness, since these containers have relatively narrow and deep hollow parts. In the case of the present invention, during a thermo-blow molding operation, the elements of the section of parison (the hollow pasty glass or polymer mass to be formed, in the language of the glass worker), between the outer edges of two parallel contiguous tips of the flared grooves of the mold used for the production of a preform with bellows, have different fates according to their position relative to these tips. Along the tips of the mold, the bottoms of the bellows of the preform form and the thickness of these bottoms is substantially that of the parison. Along the flanks of the mold, the initially flat section of parison between the internal edges of the tips of the mold, swells, and as it progressively decreases in thickness, attaches to the flanks of the grooves of the mold. At the end, if all steps have been taken to ensure that things go well, it becomes relatively thin or very thin and attaches to the bottom of the groove to form the tip of the preform, otherwise this tip is perforated and the preform produced is unusable. Under good production conditions, the thickness of the bottoms of the bellows of such a preform is greater than the mean thickness of their flanks and very much greater than the thickness of their tips. The relationship between the thicknesses of the bottoms and the tips of the bellows depends on the relationship between the width of the section of parison between two tips of the grooves of the mold and double their depth or also of the sine of the half-angle of the dihedral formed by the median planes of the flanks of the grooves. Below a minimum value of this half-angle, the tips of the bellows cannot be completely formed. The optimal value of this half-angle is between 20 and 30°, the minimum being dictated by the minimum angle of correct formation of the tips of the thermo blown part and the maximum by the maximum angle of inversion of the faces of the end connectors of the bellows. The above considerations apply without much change to the hydroforming operations for metal parisons.

In a first embodiment of the method according to the invention, using a polymer or a metal relatively flexible and elastic in the cold, (polyethylene or brass, for example) it is easy, thanks to known thermo-blow molding and hydroforming techniques, to produce a preform, according to the invention, which contains bellows with embossed flanks, the median longitudinal planes of which form dihedrals which present too large a half-angle, 45° for example, which prevents any inversion of their end connectors. Then, as the tips and the bottoms of the bellows are much less rigid than the flanks, it is easy to (1) cold compress this preform in order to give it the form of a stack of pairs of hollow plates, globally symmetrical and communicating, having small and substantially constant internal thicknesses and spacing and median longitudinal planes perpendicular to their plane of symmetry and (2) to preserve its initial shape using a suitable member while ensuring its maintenance by clamping.

In a second embodiment of the method according to the invention, by casting a preform having a shape identical to that of the preceding, made of glass or of polymer which is flexible when hot and relatively rigid when cold (polypropylene, for example), then carrying out an appropriate hot compression of this preform to give it the desired shape and then by letting the thus-produced part cool, in a suitable master, the shape given to this part is stable and final. Any device able to ensure maintenance thereof by clamping then becomes totally unnecessary.

In these first and second cases, thanks to the particular nature of the method defined above, the flanks of the bellows of the preform produced are embossed. Because of this embossing, (an alternating succession of hollows and humps, in the shape of roofs with four pitches, for example) the moment of inertia of the walls relative to their median plane increases enormously and, consequently, the rigidity of the flanks of the bellows becomes very great (>100) relative to that of their bottoms, although the thickness of these is, in the case of thermo-blow molding, much greater than the mean thickness of the flanks of the bellows. Consequently, in these two cases, the tips and the bottoms of the bellows operate as hinges which are relatively flexible in the first case and very flexible in the second. In fact, the ratio of the rigidity of the embossed flanks to that of the relatively thick bottoms of the bellows of the preform increases rapidly shortly after leaving the mold because the relatively thin flanks cool much more quickly than the relatively thick bottoms. In the two cases, the substantial rigidity of the embossed walls of the hollow plates prevents any subsequent deformation of their stacking.

In a third embodiment of the method according to the invention, the median planes of the relatively deep embossed flanks of the bellows form dihedrals of approximately 50° and their end connectors are surfaces that can be inverted. In these conditions, retaining the material of the preform of the second case mentioned above, under the action of internal depression and/or external compression forces applied to this preform, the convex surfaces of its half-bellows subjected to this force flip over and become concave and they remain like this thanks to the stable inversion of the sides of the end connectors of these half-bellows. Despite the force resulting from this deviation from their original position created by the inversion of these end connectors, any subsequent bending of the median longitudinal planes of these particularly rigid embossed plates is prohibited.

It will be noted in the third embodiment of the method according to the invention, that the inversion of the bellows of the preform actually affects only the end connectors of these bellows, because their central parts undergo only a simple fold, but the inversion of these end connectors ensures the maintenance and the stability of these folds. Such an inversion is stable because the end connectors of the central parts of the bellows are invertible surfaces, for example semi-frustra. These surfaces have such a property because the depth of the bellows and of their end connectors is great enough vis-a-vis the transverse dimension of the preform. Such an arrangement is necessary, being the second obligatory feature of an invertible surface, the first being, in the case of a frustrum, a half-angle at the peak less than approximately 60°. It is known that the inversion of an invertible surface includes a short buckling phase between the two stable states of this surface. Such a transitional buckling can exist only when the flanks of the bellows are simultaneously, not too far apart from each other and relatively deep vis-a-vis the transverse dimension of the preform, taking into account the thickness of their wall and the Young's modulus of the material used. By way of example, the depth of the bellows may, for example, taking account of these two parameters, vary from 95 to 50% of the radius of truncated end connectors. Finally it will be noted that, in the case of an accordion, this relative dimension of the bellows is, generally, from 10 to 15% only, which as a result allows the folding and stretching of their end connectors, without effort, in the absence of any bistable phenomenon.

According to the invention, an exchanger of heat between two confined fluids, which comprises in a casing one or more of these elementary exchangers, is characterized in that:
the casing is formed by two half-shells which completely surround this or these elementary exchanger or exchangers in a tight manner, following their global exterior form or forms, while creating narrow spaces with respect to them and maintaining their contact with the external centre lines of their two hollow end plates;
each half-shell encases a longitudinal half of an elementary exchanger or of the assembly formed by several exchangers and contains, at each of its ends, one or more connection half-branches, and in its bottom, one or more fixing openings;
the edges of these half-shells and of these half-branches are fixed to each other in a tight manner, and the edge or edges of this or of these openings, also fixed to one of the two connection branches of this exchanger or of each of these exchangers.

According to the invention, the mold for producing a preform of the active part of the elementary heat exchanger, defined above, comprises two metal jaws, in the form of parallelepipedic blocks, symmetrical relative to their parting line;
in each of these blocks, are relatively long hollowed-out flared grooves, relatively long, with narrow and parallel rectilinear tips and bottoms, the two flanks of which are embossed, the hollows and humps of one facing the humps and hollows of the other,
the tips of the projections separating the grooves are parallel to the parting line and, in relation to this plane, present a gap greater than their own width;
the angles formed with their plane of symmetry by the median longitudinal planes of the embossed flanks of each of the grooves of the mold are greater than a minimum angle dictated for the correct-molding conditions of the preform and, preferably, less than the maximum angle of inversion of the end connectors of the preform to be produced, this angle being dictated by the breaking point of the material used;
the ends of the flanks and of the bottoms of the grooves join to form two symmetrical surfaces, if appropriate, with an invertible profile, such as semi-frustra, which end in the parting line of the mold, the two stacking axes of these two surfaces being situated in this parting line;
these two stacking axes being those of the future feed collectors of the elementary conduits of said active part, co-axial cylinder portions are cut in each of the projections separating two contiguous grooves, in order to delimit these collectors;
at one of the ends of each of these axes a semicylindrical cavity is created, intended to mold half of one of the two connection branches of an elementary heat exchanger;
one of these semicylindrical cavities opens to the outside.

A method for producing by thermo-blow molding a glass or polymer preform of the active part of the elementary heat exchanger according to the invention, defined above, comprises the following steps:
making, by means of an extruder, with the chosen material, a relatively flat hollow parison;
inserting this parison between the two jaws of the mold defined above;
closing the jaws of the mold and, at this point, sealing the upper and lower ends of the parison in place by welding;
inserting a nozzle in the open cavity of the jaws of the mold and causing it to pierce the parison;
applying for a brief moment, inside the parison, a high pneumatic pressure, so as to produce with hot-setting by thermo-blow molding a preform of the active part which reproduces the grooves of the mold and resembles the biconvex bellows of an accordion;
withdrawing the nozzle, opening the jaws of the mold and removing the preform.

A method for the production by hydroforming of a metal preform of the active part of the elementary heat exchanger according to the invention, defined above, comprises the following steps:
introducing a flat metal tube of suitable length between the two jaws of a mold having high mechanical strength, of the type defined above, then closing these jaws and, at this point, sealing the ends of the tube in place;
inserting a nozzle into the open cavity of the mold so that it engages tightly in this tube;
applying for a very brief moment, inside the tube, a high hydraulic pressure, suitable for plating the metal on the walls of the mold, in order to produce, cold, a thin-walled preform of the active part, which reproduces the grooves of the mold and resembles the biconvex bellows of an accordion;
withdrawing the nozzle, opening the jaws of the mold and removing the preform.

Thanks to all these measures, the aims of the invention are fully realized, namely heat exchangers, suitable for operating in counter-current, conforming to the three features and to the specifications mentioned above. It will be noted more particularly that the single-piece heat exchangers according to the invention have limited production costs, due mainly to the complete absence of assembly and welding operations relating to the active part. This absence of welds is moreover a feature which is particularly valuable in all areas of industry which experience vibrations.

The efficiency of the heat exchangers according to the invention depends on the thermal conductivity and therefore on the thickness of the walls of their active part. This thickness is a function, on the one hand, of the thickness of the parison or of the metal tube mentioned above and, on the other hand, of the ratio of their circumference and the perimeter of the cross section of the preform. A single mold allows the production of preforms whose wall thicknesses can, generally, vary from single to double.

The large exchange surface required for any heat exchanger is easily obtained within the framework of the invention because the hollow plates of the active part can be numerous (up to 30, for example) and relatively long (from 50 to 150 cm, for example). This compensates for the relatively limited individual width of these plates when the mean thickness of their walls is small. In fact, any noteworthy differential pressure effecting hollow plates with thin walls brings about their greater or lesser deformation, according to their width, and thus either a compression of their separation spaces and an increase in their internal thickness, or vice versa. One or the other of these deformations would mean a decrease in the realized heat exchange. These deformations are however very small with hollow plates with embossed walls. The great rigidity of embossed thin walls allows plate widths of up to 125 mm.

When glass is used to produce the active part of the exchanger, the negative effects of such a differential pressure can however be quite easily compensated, if the hollow plates are given a width which is relatively greater than that indicated above, while increasing the thickness of the embossed walls of these plates. Because glass has a thermal conductivity double that of water, this double increase becomes easily possible for numerous applications. It will be noted that the relative excess pressure resistance of the active part of a heat exchanger equipped with a casing is substantial (two to three bars, for active part walls of 0.5 mm). On the other hand, any pressure inside the casing which is too much greater (more than 100 millibars for example) than that inside the active part would mean a crushing of this part. This particular case of use of a heat exchanger according to the invention is therefore to be prohibited.

The small respective passage thicknesses of the fluids in the exchanger are determined by the internal thickness of the hollow plates and by that of their separation spaces, these two thicknesses being substantially equal when the two fluids concerned are of the same nature. On the other hand, when one is a gas and the other is a liquid, their mass flow rates and their respective thermal capacities will be taken into consideration to best determine the thicknesses of the passages to be produced.

The total passage section of the fluid confined in the exchanger is the product of the section of each elementary conduit, formed by each pair of hollow plates of the active part, times the number of these plates. The surface of the section of an elementary conduit is limited for the reasons given above but the number of hollow plates can be relatively large. Moreover, when the thermal energy to be exchanged is substantial, it is easy to assemble in parallel numerous heat exchangers, equipped or not equipped with casings or also to install numerous elementary heat exchangers in parallel in a single casing.

As regards the small bulk of a heat exchanger according to the invention, this results from the fact that, in spite of a possible great length, the two measurements of the cross section of its casing are relatively small and close to each other since it contains only a single active part.

As regards its low weight, this results from the fact that the polymer used (polypropylene, for example), has a relatively low density and the walls of the active part and of its casing, which together constitute the apparatus, have a priori limited thicknesses. In the case of active parts made of metal (stainless steel or titanium for example), the thickness of the walls can remain small because of the great mechanical strength of the metal, which compensates for the greater density and allows the unit to maintain a low weight. Such a property will be less marked in the case of glass.

It will be noted here that the good resistance to corrosive fluids is an intrinsic property of the majority of the polymers likely to be used for producing the parts comprising the heat exchanger according to the invention. It is of course the same for glass and special metals, provided for this purpose.

As regards the low production cost of the apparatus, this results from the fact that (1), in the case of a heat exchanger for two confined fluids, which comprises only one single-piece active part, it comprises at most three parts which are easy to produce and to assemble, (2) the small number of automatic operations to be realized to this end and (3) the amortization, over a very large amount of units, of the generally high price of the molds. As regards the automated equipment for the implementation of the processes of production, it will be noted that they are common in plants producing containers of all shapes, made of plastic, glass or metal, and that the modifications and additions to be made to them according to the invention are within the capacities of any professional of the trade concerned.

It will be noted that the use of a suitable polymer, and in particular polypropylene, ABS or polycarbonate, for the production of the elementary heat exchangers according to the invention will be the most general case. It will be the same for heating radiators and, more generally, air conditioning inside automobiles, which will comprise an elementary heat exchanger and its casing. In these radiators, the engine cooling water or the liquid coolant will circulate in the active part, and in counter-current all around this part, a forced-air flow. Another example, comparable to the preceding, is that of condensation heat exchangers, used in washing machines and dryers. Another particular example is that of the hot water central heating radiators which, generally, will use several elementary heat exchangers which are bare (without a casing), installed in parallel. It will be the same for the heat exchangers of heat pumps, installed in a water course. Elementary exchangers made of glass will allow the requirements of numerous chemical laboratories to be satisfied. As regards those made of a suitable metal, they will satisfy the wishes of certain high-technology industries which process corrosive fluids at high temperature. It will be noted that heat exchangers with small dimensions will meet the wishes of producers of electronic equipment who wish to have more efficient means of cooling certain components of their apparatuses and in particular microprocessors and power transistors.

The features and advantages of the invention will become clearer in the following descriptions of embodiments, given as non-limitative examples, which are illustrated by the drawings below in which:

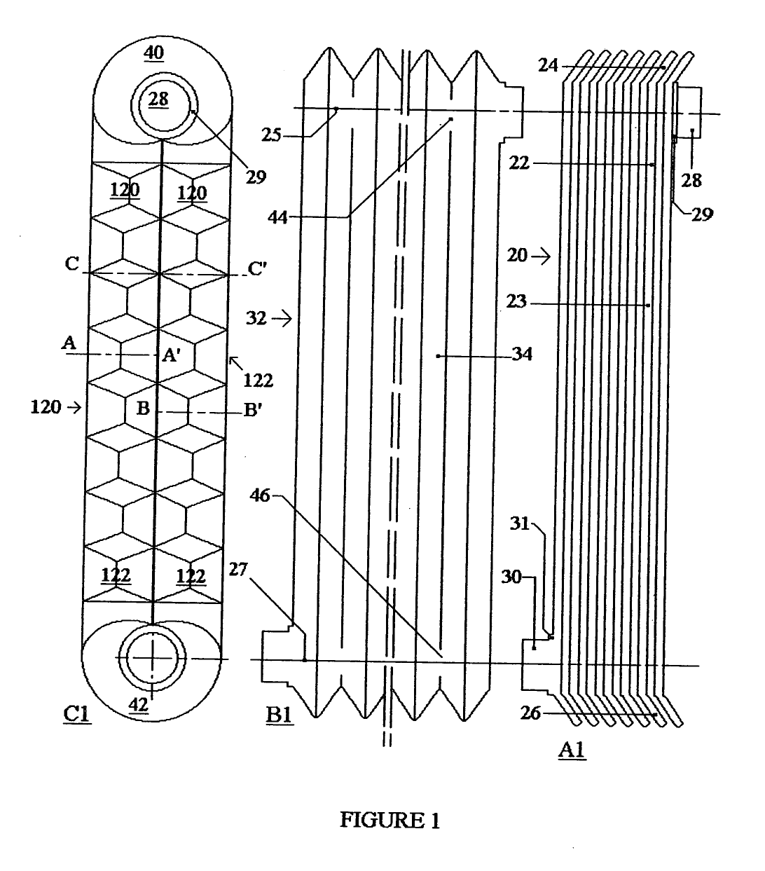

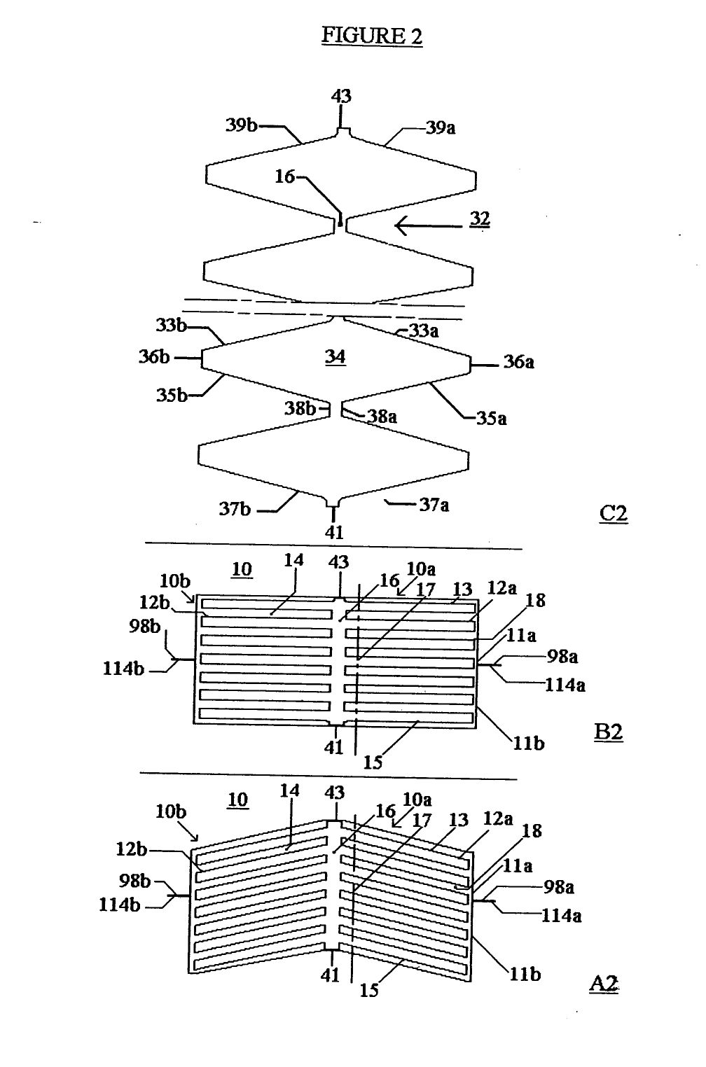

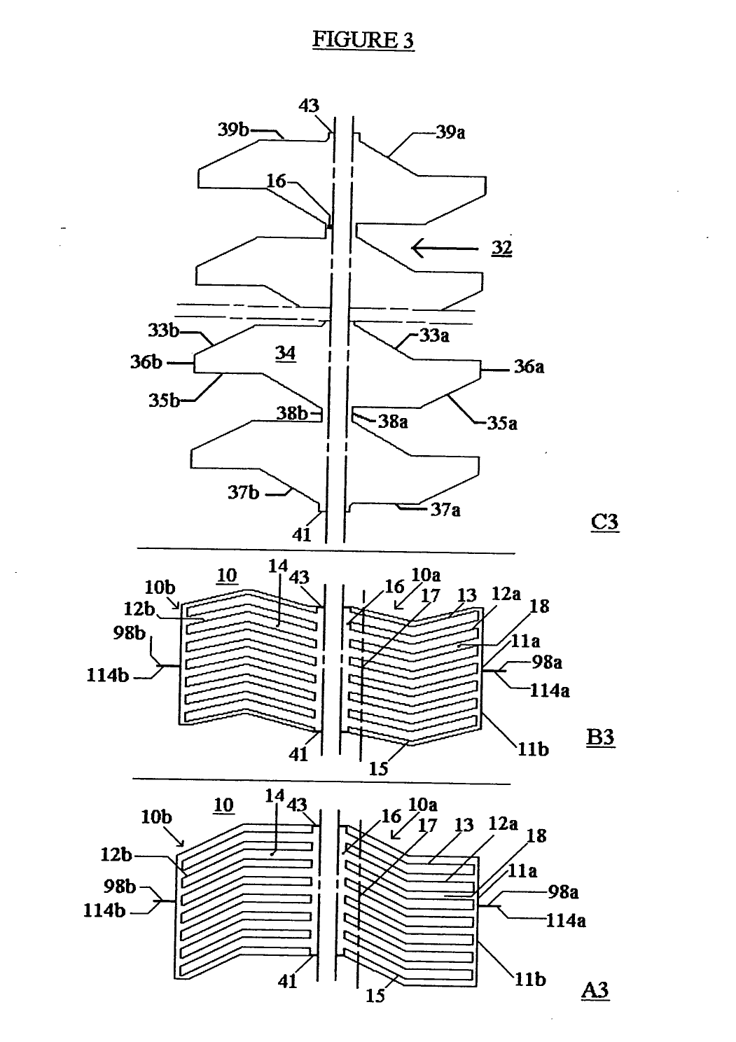

FIG. 1 represents on the right in A1 a longitudinal section along the plane 17 of FIGS. 2 and 3 below (simplified section) of an elementary heat exchanger according to the invention, in the centre, a simplified longitudinal section B1 of the preform of this exchanger and, on the left, an actual front view C1 of this preform or of this exchanger, (the simplified illustrations A1 and B1 having the embossing deleted);

FIG. 2 represents actual transverse sections A2, B2 and C2 of two elementary heat exchangers according to the invention, made along the section axis CC′ which runs along the median line between a hollow and a hump of the embossing of the walls of the exchanger represented in C1;

FIG. 3 represents actual staggered transverse half-sections A3, B3 and C3 of two elementary heat exchangers according to the invention, made along the staggered section axes AA′ and BB′, which respectively cross a hollow and a hump of the embossing of the walls of the exchanger represented in C1;

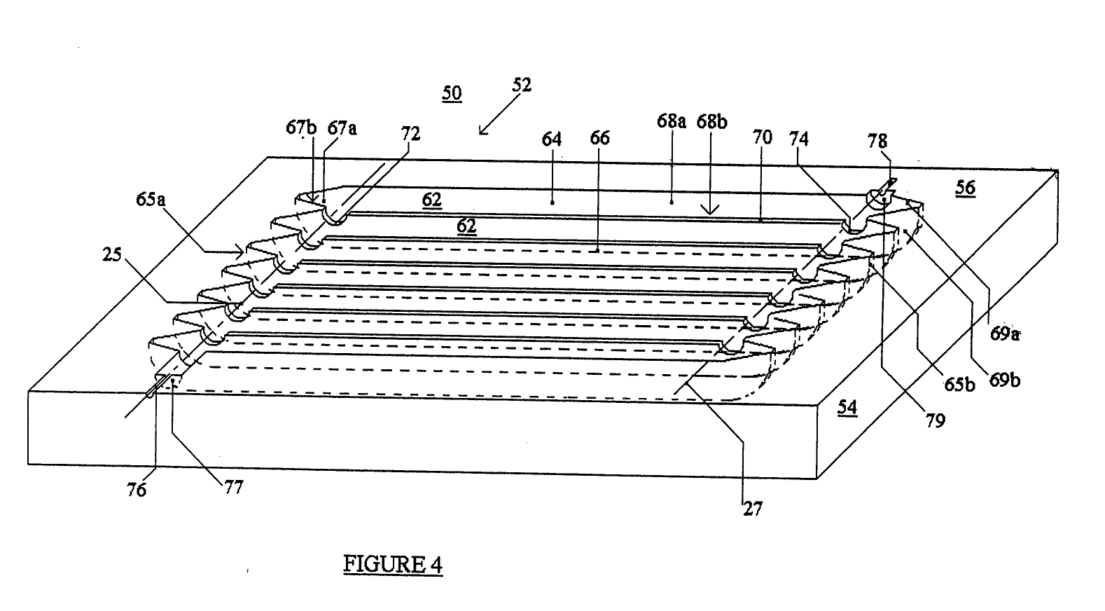

FIG. 4 represents a simplified perspective view of the block constituting the half-mold for producing the preform of the active part of the elementary heat exchanger according to the invention;

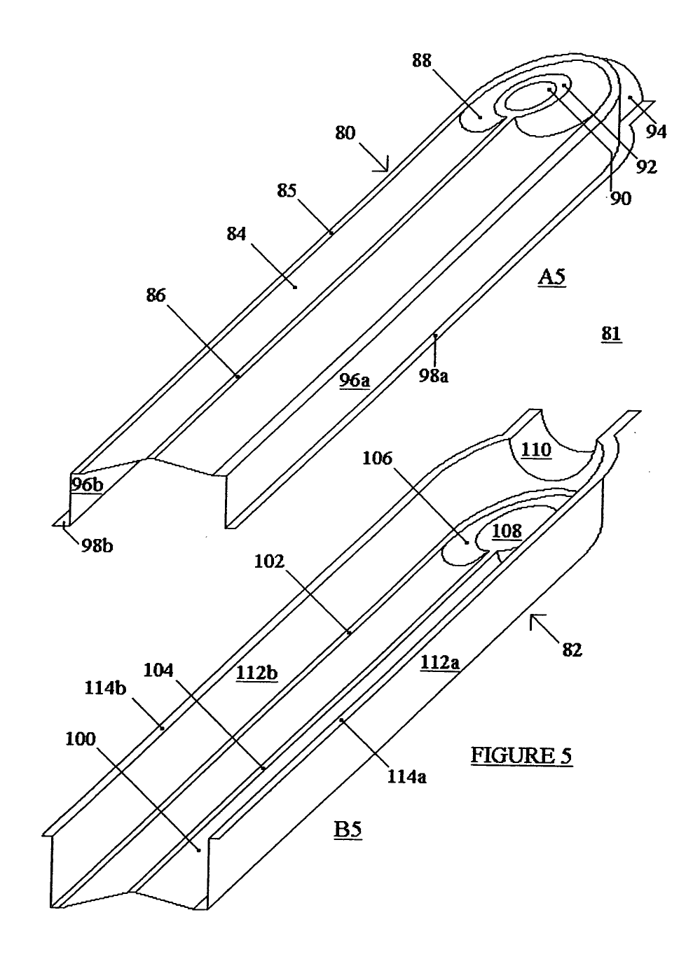

FIG. 5 represents in simplified perspective the half of each of the two half-shells of the casing of an elementary heat exchanger according to the invention.

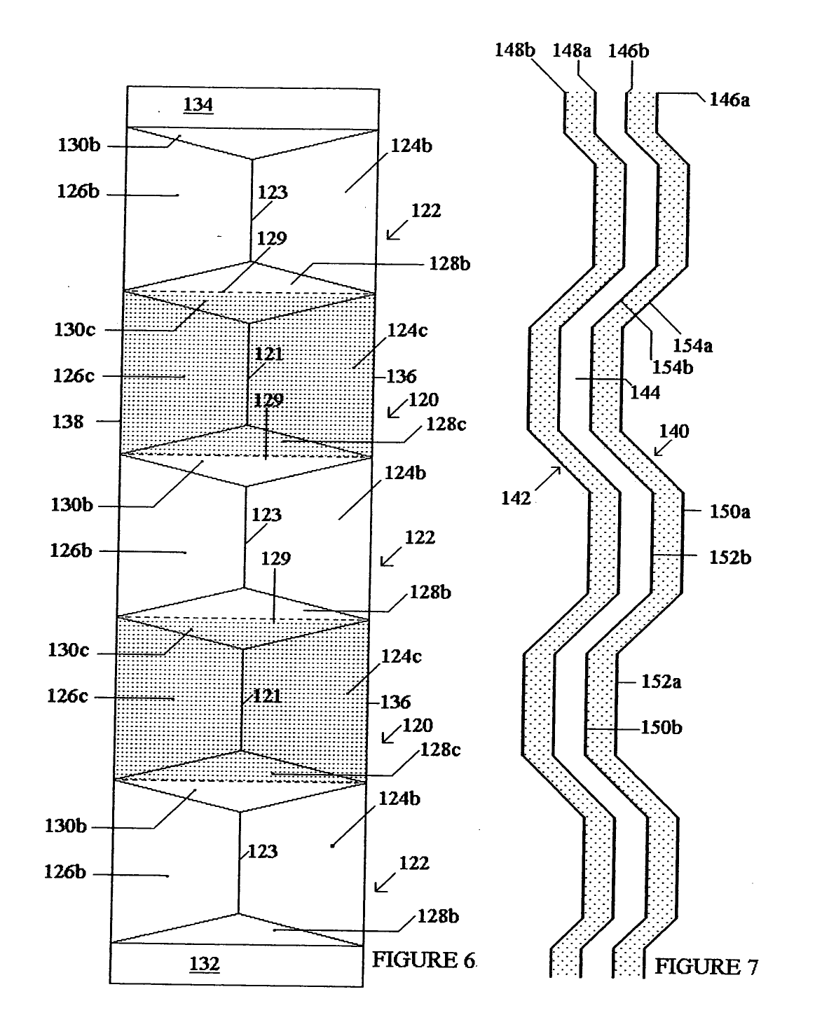

FIG. 6 represents the front view of the embossed wall of a hollow plate of a single-piece heat exchanger or of one of the embossed flanks of the mold concerned;

FIG. 7 represents the sectional view of two contiguous hollow plates with embossed walls of such an exchanger.

FIGS. 1, 2 and 3 concern two embodiments of an elementary heat exchanger according to the invention. For one of them, the median longitudinal planes of the pairs of elongated hollow plates of these exchangers together form 150° dihedrals (sections A2 and A3) and, for the other, they are perpendicular to their plane of symmetry (sections B2 and B3). In the first case, the exchanger was produced by compression and inversion of the bellows and end connectors of a preform in the shape of an accordion and, in the second, by symmetrical compression of these bellows and these connectors.

View C1 shows the embossing of the end walls of an elementary heat exchanger or of a preform of this exchanger. This embossing is formed by an alternating succession of hollows 120 and humps 122, in the shape of roofs with four pitches (described in detail in FIG. 6). Three staggered transverse section planes are created to be able to describe the geometrical results of this embossing: the half-planes AA′ and BB′ respectively through a hump 122 and a hollow 120 of the wall of a plate and the plane CC′, along the line separating the hollows and the humps of a pair of plates.

According to FIG. 2, the transverse section A2 shows the cross-section 10, along the section plane CC′, of the active part of an exchanger having small dimensions and those 11a-b of the two half-shells of its casing. Section 10 of the active part is shaped like a vertebral column of a fish, provided with seven pairs of hollow fins 12a-b which are oblique and parallel to each other. The internal cavity 14 of each fin 12a-b is narrow (2 mm, for example) and the two globally symmetrical fins of a pair communicating with each other via a common channel 16, having substantially the same width as the internal thickness of the cavity 14. The walls of these fins 12a-b are made of polymer, endowed with a good mechanical stability up to at least 100° C. (polypropylene for example) and they have a mean thickness of 0.5 mm and a width of 25 mm. The gap 18 between two contiguous fins is almost equal to the internal thickness of the cavity 14. The distance between the external walls 13-15 of the two end fins of the cross-section 10 is 35 mm.

The simplified longitudinal section A1 (embossing deleted) of an active part according to the staggered section plane 17 of the section A2 shows seven elementary conduits, constituted by seven pairs of globally symmetrical elongated hollow fins 22, arranged like those 12a-b of the transverse section A2. These globally symmetrical elongated fins 22 share the common central channel 16, which occupies all of the plane of symmetry of the exchanger. The elongated fins 22 contain rectilinear central parts 23, the ends of which are linked to each other by semi-frustra 24 and 26 with hollow walls. The centres of these two series of semi-frustra are aligned on two axes 25 and 27, at once parallel to each other, perpendicular to the outside edges of the hollow plates 22, and situated in their longitudinal plane of symmetry. These axes 25-27 are those of two main feed lines of each of the elementary conduits, constituted by each pair of hollow plates 22. These main lines open onto two connecting branches 28-30 of the active part 20, which are represented, arranged in opposite directions and equipped with fixing shoulders 29-31 (see sections A1 and C1). The centre distance of axes of the branches 28-30 can be substantial (up to 150 cm) but, in practice, it depends on the capabilities of the machines available for producing preforms of the active parts of the elementary exchangers.

The transverse section B2 is made following the section plane CC′ of an active part of a heat exchanger whose median longitudinal planes of the embossed hollow fins are perpendicular to their global plane of symmetry. The same references are used for FIGS. A2 and B2. The only difference between the hollow fins 12a-b of the two figures relates to the orientations of their median planes relative to their plane of global symmetry.

The longitudinal section B1 of the simplified preform 32 (embossing deleted) of the active part 20 and its transverse section C2 along the cutting plane CC′ show that this preform 32 is shaped like a stack of globally biconvex bellows 34, the flanks of which 33a-b and 35a-b are comparable to those of an accordion. On the sections B1 and C2, for convenience, the bellows represented, number only four. Along section C2, the opposite tips 36a and 36b of each bellow are at once shaved, fine (0.3 mm for example) and broad (2 mm for example), the distance which separates these tips being approximately 50 mm in the case of the example chosen. The bottoms 38a-b of these bellows are flat and have the same width (2 mm) but a noticeably greater thickness (1.2 mm for example). In the case of the exchanger with small dimensions chosen by way of example, the base of each bellow 34 measures approximately 17 mm with a depth of 25 mm. These dimensions allowed a good penetration of the section of parison concerned as far as the bottom of the grooves of the mold used for the production of this preform. In these conditions, the angle at the peak formed by the median planes of its flanks 33a-b and 35a-b is approximately 50°, or 25° for the half-angle formed by these median planes and their transverse plane of symmetry and 10° or 40° for those of the flat lands of the hollows and humps of the embossing. These last half-angles are greater than the minimum clearance angle of any molded part.

Along the real front view C1 and the simplified longitudinal section B1, the ends 40 and 42 of each bellows 34 of the preform 32 are shaped like portions of semi-frustra. The centres of these frustoconical portions are aligned on the axes 25-27 of the preforms of the future main feed lines 44-46, which have, for example, a diameter of 16 mm and end in connecting branches 28 and 30, represented in A1 and C1. The longitudinal dimension of the bellows 34 is, of course, that shown for the fins 22 of section A1. The convex joints of the flanks 37a-b and 39a-b of the two external half-bellows of the preform 32 comprise longitudinal projections 41-43, intended to serve as supports for the centres of the convex and concave walls of the casing of the active part 20 (see in A2, the cross section 11a-b of this casing). The distance between the support projections 41-43 is for example 130 mm, for the preform 32 with seven bellows mentioned above.

FIG. 3 represents the transverse sections A3 and B3 of the two preceding elementary heat exchangers, made along the staggered section half-planes AA′ and BB′ of the front view C1, which respectively cross a hollow and a hump of the embossing of the walls of the plates of these exchangers. Similarly, the two transverse half-sections, represented in C3, are those of a preform with embossed walls, made along these same section half-planes. The references given to the sections of FIGS. 2 and 3 are identical. The walls of the plates of an exchanger and those of the bellows of a preform represented in sections A3, B3 and C3 (half-planes of the section AA′ and BB′) differ from those represented in A2, B2 and C2 in that, instead of appearing rectilinear like the latter (cutting plane CC′), the walls of the fins 12a and those 33b and 39a of the bellows 34 in FIG. 3 present a hollowed fold and the walls of the fins 12b and those 33b and 39b of these bellows, a humped fold.

FIG. 4 represents a simplified perspective view (embossing erased) of one of the jaws 52, in the shape of a thick parallelepipedic block 54, of the mold 50 for producing the preform 32. In the case of a preform made of polymer or glass, the block 54 can be made of aluminium and, in the case where this preform must be made of metal, this block can be made of steel with high mechanical strength. The upper face 56 of the block 54, which constitutes the parting line of the mold, contains a relatively large number of contiguous, elongated, flared grooves 62. These grooves 62 contain a globally rectilinear central part 64, having an average cross section in the shape of an isosceles trapezoid. The rectilinear bottom 66 of each groove 62 is narrow and corresponds to the small base of the trapezoid. The flanks 68a-b of these grooves 62 are identical to the flanks 33a-35a of the preform 32. The rectilinear tips 70 of the projections separating these grooves 62 have widths identical to those of the bottoms 38a-b of the bellows 34 of FIG. 2 (view C2). As regards the bottoms 66 of the grooves 62, their width is that of the internal width of the fins plus twice the width of their walls, i.e. 3 mm, in the case of the example presented. Symmetrical portions of frustra 67a-b and 69a-b (portions greater than one quarter) constitute extensions of the oblique flanks 68a-b of the flared grooves 62 which combine and end in the parting line 56 of the mold. The ends of the narrow rectilinear bottoms 66 of the grooves 62 are extended with quarter cylinders 65a-b which end at the parting line 56. Portions of cylindrical surfaces 72 and 74, 16 mm in diameter, for example, cut in the projections separating the grooves 62, from portions of frustra 67a-b and 69a-b, constitute mold parts which will create the edges of the preforms of the main feed lines 44 and 46, represented in view B1 of FIG. 1. The centres of these portions of cylindrical surfaces 72-74 are aligned on the axes 25-27 of two half-cavities 76 and 78, (12 mm in diameter for example), equipped with half-shoulders 77-79. These half-cavities 76 and 78 are hollowed out from the upper face of the block 54 and they will create the connecting branches 28-30 of the preform 32 and their shoulders 29-31. These axes 25-27 are parallel to each other, perpendicular to the tips 70 of the projections separating the grooves 62 and situated in the parting line 56 of the mold. The half-cavity 76 is open to the outside.

FIG. 5 represents in perspective, in A5 and B5, the simplified partial views (embossing erased) of two half-shells 80 and 82 which, assembled and welded, constitute the casing 81 of the elementary heat exchanger according to the invention. These two half-shells were produced using techniques which are common in the industry (thermo-blow molding of a polymer sheet or drawing of a metal foil). Each of these half-shells 80-82 is intended to encase a longitudinal half of the active part 20 of the elementary exchanger and to form the halves of the two connecting branches 94 and 110 of the casing 81.

The partial view A5 of the half-shell 80 shows a convex external wall 84, comprising, all around, a narrow continuous flat surface 85 and, in the middle, a longitudinal projection of the same width 86. This flat surface and this projection are respectively suitable for creating the small gap provided for above (by way of example, 1 mm) relative to the overall limits of the active part 10, with the exception however of the projections 41-43 supporting this active part. At the end of the half-shell 80, there appears in relief the form 88 of the frustrum portion 40 (see view C1 of FIG. 1) which serves to connect the two rectilinear elements of the pair of external convex longitudinal fins 13 (see view A2 of FIG. 2). In the centre of the form 88 a circular opening 90 appears, the surround 92 of which is intended to be applied and welded to the shoulder 29 of the connection branch 28 of the active part 20. At the end of the half-shell 80, there is seen the extreme part of a connection half-branch 94 of the casing 81 of the active part 10. The greater the number of pairs of longitudinal fins 22, the higher are the flanks 96a-b of the half-shell 80. Two rims 98a-b surround the external edges of the half-shell 80 (flanks 96a-b and half-branch 94). These rims also appear in A2 in FIG. 2.

The partial view B5 of the half-shell 82 shows a concave external wall 100, comprising all around a narrow continuous flat surface 102 and, in the middle, a longitudinal hollow of the same width 104. This continuous flat surface and this hollow are respectively suitable for creating a small gap, similar to that mentioned above. At the end of the half-shell 82, there appears the hollowed-out form 106 of the frustrum portion 42 which serves to connect the two rectilinear elements of the pair of external longitudinal concave fins 15 (section A2). In the centre of the form 106, a disk 108 appears, situated opposite the opening 90 of the half-shell 80. At the end of the half-shell 82, the connection half-branch 110 of the casing 81 is arranged. The flanks 112a-b of the half-shell 82 are the same height as those 96a-b of the half-shell 80. Two rims 114a-b surround the exterior edges of the half-shell 82. These rims 114a-b are intended to be welded to the rims 98a-b of the half-shell 80.

FIG. 6 represents the enlargement of two things, (1) a front view of a longitudinal half of the embossed wall of a hollow elongated plate 22 of an actual elementary heat exchanger and (2) a similar front view of the embossed flank of the grooves 62 of a real half-mold, which can be used for the production of preforms of this exchanger. In both cases, the embossed walls of the preform or of the grooves of the half-mold used for its production comprise an alternating succession of hollows 120 and humps 122, in the shape of roofs with four pitches, two in the shape of a trapezoid 124-126 and two in the shape of isosceles triangles 128-130. The depth of a hollow 120 and the height of a hump 122 are each 2.5 mm for example. The indices b and c, given to the references of these of these four pitches, respectively identify their humps and hollows, represented shaded. The section half-planes AA′ or BB′ mentioned above cross at their mid point, the hollowed-out trapezoids 124c and 126c or the humped trapezoids 124b and 126b. The joining lines of the trapezoids 124 and 126 are numbered 121 and 123 depending on whether these trapezoids belong to hollows or humps. It will be noted that each of two embossed flanks 33-35 of a real preform or of those 68a-b of a groove 62 of a real half-mold comprises an alternating sequence of hollows and humps facing an alternating sequence of humps and hollows. The dotted lines 129 are represented symbolically to distinguish the two coplanar pitches 128b and 130c or 130b and 128c which belong respectively to a hump or to a hollow, each dotted line being the large diagonal of a rhombus. The cutting plane CC′ mentioned above follows these lines 129. The narrow rectangles 132 and 134, which appear at the two ends of the succession of hollows and humps 120-122 are flat zones connecting the central part (1) of the hollow plates 22 and their end connectors 24-26 in the case of the exchangers or (2) the grooves 62 of the half-mold with their ends in portions of frustra 67a-b and 69a-b. The edges 136 and 138 represented in FIG. 6 are the tip lines 36 or bottom lines 38 of the preforms 32.

FIG. 7 represents the enlarged view in longitudinal section along the median lines 121-123 of the central parts of two contiguous hollow plates 140 and 142 with embossed walls, separated by a space 144. Along this centred longitudinal section, the embossing described in FIG. 6 manifests itself, after controlled compression of the preform, in the creation of hollow plates 140-142, with walls 146a-b and 148 a-b, formed by a succession of humps, such as 150a or 152b, and hollows such as 152a or 150b, linked together by pitches of approximately 30°, such as 154a-b. The gap between two extreme lines 150a and 150b is approximately 5 mm. The internal thickness of a hollow plate 140-142 with embossed walls is substantially constant, 2 mm for example. The width of the corrugated space 144 which separates them is itself substantially constant and the same order of magnitude as the internal thickness of the plates.

In these conditions, the effect of such a embossing is to give to the moment of inertia of the wall relative to its median plane a value which is several hundred times greater than that of the same moment of inertia of a plane wall half a millimetre thick. The rigidity of the central part of the wall is increased in the same proportions, but that of the tips and the bottoms of the bellows of the preforms remains very small, which allows these tips and these bottoms to act as flexible hinges, taking a radius of curvature which is very small at the time of the controlled compression of the preform, while the flanks remain globally flat.

Thanks to these arrangements, the heat exchanger according to the invention appears with the advantages of all its production and use features. As regards its production, it will be noted firstly that the molds concerned require usual production processes and that they will be used as part of techniques which are customary in the industry. It is the same for automated equipment such as extruders, compressors and travel systems, which are found in all plants for producing containers of all shapes from polymer or glass, intended to contain the most diverse fluids. It is the same for the equipment, operating at very high water pressure, used for the hydroforming of metal parts.

Starting from a preform in the form of a stack of globally biconvex bellows comparable to those of an accordion, leaving molds according to the invention, the transformation of this preform 32 into an active part 20 of the elementary heat exchanger according to the invention requires an operation which is novel in itself, realized with a particular machine tool suited for this purpose. This operation constitutes either a symmetrical compression of the bellows of the preform or a rapid inversion of the convex half-bellows of this preform, oriented in a first direction, towards their globally symmetrical half-bellows, orientated in a second direction (they were convex and they become and remain concave). In both cases, the operation is realized by applying a compression force to the bellows parallel to their stacking axis. This force will be created by a controlled depression applied inside the preform 32 and/or by a piston with a convex profile, moving at a speed which is also controlled, combined with a fixed support with a concave profile. This piston and this support will have the same longitudinal dimension as the fins of the active part which is finally produced. Where the compression force is created by a depression, it will be noted that the external omnidirectional forces which will result from this will act in the direction of the easiest movement, namely the stacking axis of the bellows of the preform. It will be noted that the bistable projections, constituted by the half-bellows of the preform which, in their second stable state, have assumed the form of concave walls of oblique and hollow longitudinal fins can, by way of illustration, resume their first state by the simple application of a sufficient pressure inside the finished active part, but on condition that the walls of the latter have retained or regained a minimal flexibility. It is the same for the half-bellows which have been subjected to a symmetrical compression.

It is of course necessary, in order that all of these operations are possible and proceed correctly, that the preform introduced into the particular machine which must carry out such a compression or such an inversion contain tips and bottoms which are sufficiently flexible and elastic. This is in order that their breaking point is relatively high and that the inversion or the symmetrical compression of the flanks concerned of the central parts of the bellows and of their end connectors can occur without the risk of cracking or bursting. Where the transfer from the mold to the machine compressing the preform would include a relatively significant dead time, this preform would cool and, in particular in the case of glass, could see its flexibility reduced below the minimum limit dictated by a good inversion or a good compression. In this case, the machine in question would have to include, upstream, means for reheating the preform, in order to restore the flexibility which it requires so that the half-bellows concerned can be inverted without being damaged.

It will be noted that the hollow connectors of the ends of the central parts of the globally symmetrical hollow plates of an elementary heat exchanger according to the invention as well as the biconvex connectors of its preform, which have been described above, are portions of frustra. This type of surface is of course not the only one which can be used. In fact, any invertible surface (a very flared pyramid with a square base and a shaved summit is invertible relative to a plane of inversion containing its base for example) can be used to constitute the biconvex connectors of the ends of the central parts of the bellows of the preform according to the invention.

As regards the embossing of the flanks of the bellows, it will be noted that roofs with four pitches are not the only way to realize these, and humps and hollows in the shape of domes and bowls, with substantially rounded bottoms, are also possible.

As regards the production and the installation of the casing of the elementary heat exchanger, it will be noted that these operations also require techniques which are customary in the industry. As regards the tight fixing of the half-shells to one another and to the connecting branches of the active part, tight joints and rims which are able to fit into one another and remain there can of course be provided.

As regards the orientations in opposite directions of the connecting branches of the active part, it is obvious that these different orientations allow a better circulation of the fluids inside the internal and external parts, but they can, without serious damage, be identical.

As was stated above, the elementary heat exchanger according to the invention, surrounded or not by a tight casing, described above, has all the features necessary for this type of apparatus and it satisfies all the particular specifications relating to same. It is of course not limited to the embodiments described.

1. A method for producing a heat exchange element having great efficiency, limited bulk, small weight, low production cost and, generally, intrinsic stability, characterized in that it comprises the following steps:
producing in a mold (50), by thermo-blow moulding or hydroforming, a preform (32) made of a suitable material, constituted by a stack of globally biconvex bellows (34), relatively deep relative to the transverse dimension of the preform and comparable to those of an accordion, said bellows comprising elongated central parts, equipped with end connectors (40-42), flanks (33-35), tips (36) and bottoms (38) having respectively appropriate shapes so that these flanks (33-35) have a much greater rigidity than those of the bottoms (38) and the tips (36), said stack itself being equipped with two transverse connections (28-30), centred on the stacking axes (25-27) of said end connectors (40-42);
the elements constituting this preform (32) having suitable temperatures, flexibilities and elasticities, applying an internal depression and/or external compression forces to them, parallel to the stacking axis of the bellows, up to the point where the thus-produced compressed part (10) becomes a stack of pairs of hollow plates (12-22), communicating (16) and globally symmetrical, with substantially constant small internal thickness (14) and spacing (18)
allowing the single-piece part (10) so manufactured to cool, while keeping it compressed;
if necessary, after cooling the thus-produced part (10), surrounding it with a member (81) ensuring its clamping, in order to maintain at their initial values the spaces between the walls of the pairs of plates (22).

2. The method for producing an elementary heat exchanger according to claim 1, characterized in that the mold (50) to be used for its implementation comprises flared grooves (62) with rectilinear, narrow and parallel tips (70) and bottoms (66), the flanks (68a-b) of these grooves (62) are embossed, the humps of one flank facing the hollows of the other.

3. The method for the production of an elementary heat exchanger according to claim 2, characterized in that the median longitudinal planes of the embossed flanks (68a-b) of the mold (50) form angles of 20 to 30° with their plane of symmetry and their end connectors (67a-b and 69a-b) have profiles with invertible surfaces.

4. Heat exchange element (20) formed by a stack of hollow plates (14) equipped with two transverse feed manifolds connected to two connecting pipes (24-26), characterized in that:
this element (20) is a single active part without assembly or welding;
the internal faces of the walls (12a-b or 150a-b/152a-b/154a-b) of all the hollow plates (22 or 140-142) are without contact with each other, and the same applies to the external faces of the walls of two contiguous hollow plates (140-142);
the internal and external faces of the walls of all the hollow plates are at all points separated respectively from one another by narrow, substantially constant, spaces (14 or 144);
each hollow plate (22) is symmetrical with another hollow plate and both communicate through a side of channel (16) common to all the plates, in order to form a pair of hollow plates constituting an elementary conduit of said active part (10);
each elementary conduit [of the active part (10) has two elongate hollow central portions (23), the ends of which are connected by two hollow connectors (24-26), through which the two feeding collectors (44-46) of the heat exchanger pass.

5. Elementary heat exchanger (20) according to claim 4, characterized in that the walls (150a-b/152a-b/154a-b) of the pairs of hollow plates (140-142) are embossed and globally symmetrical, but their median longitudinal planes are perpendicular to their plane of symmetry.

6. Elementary heat exchanger (20) according to claim 4, characterized in that the walls (150a-b/152a-b/154a-b) of the of the pairs of hollow plates (140-142) are embossed and globally symmetrical, but their median longitudinal planes together form dihedrals of 120 to 160° and their end connectors (24-26) have been made from invertible surfaces.

7. A preform (32), realized by implementing the first step of the method according to claim 1 for producing a single-piece elementary heat exchanger, characterized in that:
it comprises a stack without welding of globally biconvex bellows (33, 35, 37, 39) comparable to those of an accordion;
the ends of the central parts of these bellows are provided with symmetrical connectors which are, if appropriate, invertible (40-42);
the bellows of this stack have shaved tips (36a-b) and narrow bottoms (38a-b), the rigidities of these bottoms and tips are very small relative to that of their flanks (33a-b/35a-b/37a-b/39a-b);
the flanks of the bellows and those of the end connectors (40-42) have substantial depths, relative to the transverse dimension of the preform (32).

8. The preform (32) according to claim 7, characterized in that, in order to ensure a suitable rigidity of the flanks (33a-b/35a-b/37a-b/39a-b) of the bellows, each flank presents an alternating succession of hollows (120) and humps (122), in particular in the form of roofs with four pitches, the hollows of one flank corresponding to the humps of the other.

9. Heat exchanger for confined fluids, comprising at least one active heat exchange element (20) according to claim 4, installed in a casing (81), which completely surrounds said element (20), closely matching its overall outer shape, while still preserving narrow gaps with respect thereto and allowing the passage of the two connection pipes of the active element (20), characterized in that:
the casing (81) is formed by two half-shells (80-82);—each half-shell (80-82) encases a longitudinal half of the active heat exchange element (20) and comprises, at each of its ends, a connection half-branch (94-110), and in its bottom, an opening;
the edges (98a-b and 114a-b) of these half-shells and of these half-branches are fixed to each other in a tight manner, and the edge or edges (92) of these openings (90), also fixed to one of the two connection branches (28-30) of this active heat exchange element (20).

10. A mold (50) for the production of a preform (32) of the active part (20) of an elementary heat exchanger, realized according to the method of claim 1, characterized in that:
it comprises two metal jaws (52), in the form of parallelepipedic blocks, symmetrical relative to their parting line (56);
in each of these blocks (54), are hollowed-out elongated flared grooves (62), with rectilinear, narrow and parallel tips (70) and bottoms (66), the flanks (68a-b) of which are embossed, the hollows and humps of one facing the humps and hollows of the other,
the tips (70) of the projections separating the grooves (62) are parallel to the parting line (56) and they present, relative to this plane, a gap greater than their own width;
the angles formed with their plane of symmetry by the median longitudinal planes of the flanks (68a-b) of each of the grooves (62) of the mold are greater than a minimum angle dictated by the correct-molding conditions of the tips of the preform and, preferably, less than a maximum angle of inversion dictated by the breaking point of the material used;
the ends of the flanks (68a-b) and of the bottoms (66) of the grooves (62) join to form symmetrical surfaces, if appropriate, with an invertible profile (67a-b and 69a-b), which end at the parting line (56) of the mold, the two stacking axes (25-27) of these faces being situated in this parting line;
these two stacking axes (25-27) being those of the two future main feed lines (44-46) of the elementary conduits of the active part, cylinder portions (72-74) are cut in each of the projections separating two contiguous grooves, in order to delimit these main lines;
one of the two ends of each of these axes (25-27) comprises a semicylindrical cavity (76-78), provided for molding half of one of the two connection branches (28-30) of the active part (20);
one of these semicylindrical cavities (76) opens to the outside.
